(19) United States
(12) Patent Application Publication
(10) Pub. No.: US 2018/0247122 A1
(43) Pub. Date: Aug. 30, 2018

(54) METHOD AND SYSTEM OF PROVIDING INFORMATION PERTAINING TO OBJECTS WITHIN PREMISES

(71) Applicant: VimAl Oy, Espoo (FI)

(72) Inventors: Jiang Dong, Espoo (FI); Antti Ylä-Jääski, Espoo (FI); Yu Xiao, Helsinki (FI)

(21) Appl. No.: 15/444,628

(22) Filed: Feb. 28, 2017

(51) Int. Cl. G06K 9/00; G06T 7/73; G06T 7/579

(52) U.S. Cl. CPC G06K 9/00671; G06T 7/74; G06T 2207/20092; G06T 2207/10028; G06T 2207/30244; G06T 7/579

(57) ABSTRACT

A method a system of providing information pertaining to an object within a premises. The method includes obtaining images of the premises, processing the images to identify at least one object and its corresponding location within the premises, creating a three-dimensional point cloud of the premises, the identified at least one object being represented by at least one point in the three-dimensional point cloud, storing information pertaining to the identified at least one object, the information pertaining to the identified at least one object including location information of the identified at least one object, receiving a given image captured within the premises, identifying a location and a viewing direction from which the given image was captured, and locating at least one object in the given image, based upon the location and the viewing direction, and the location information. The system includes a server arrangement and a database arrangement.

### TECHNICAL FIELD

The present disclosure relates generally to indoor navigation; and more specifically, to methods and systems of providing information pertaining to objects within a premises.

### BACKGROUND

Traditionally, navigation systems included in portable devices (such as smartphones, tablets, and so forth) are used by people for navigation in unfamiliar environments. Such environments include outdoor environments like theme parks, archaeological sites, open-air marketplaces and so forth, and indoor environments like museums, shopping malls, airports and so forth. Further, navigation systems for indoor navigation find application in location-based services such as electronic multimedia guides in museums or historical places or augmented reality navigations or similar.

Generally, navigation systems are widely used for outdoor navigation. However, adoption of such systems for indoor navigation has been minimal. The development of indoor navigation systems has been known to encounter challenges such as requirement of detailed and up-to-date information (such as indoor maps) of the indoor environment (or premises), requirement of comprehensive site survey for generation of radio maps (such as radio environment maps or REMs), need for radio beacons, and so forth.

Conventional image-based indoor navigation systems locate a user within an indoor premises by analysing an image of the indoor premises, captured by the user, and subsequently identifying a location of the user by recognition of objects within the image and matching the results with pre-defined object database that stores the locations of each object. Lack of up-to-date two-dimensional and/or three-dimensional coordinates of objects within the premises significantly lowers accuracy and use of the conventional image-based indoor navigation systems.

In the conventional image-based indoor navigation systems, the recognition of objects within the image is performed in real time. However, such systems suffer from drawbacks such as shifting of objects (for example change in position of chairs and signboards) within the premises, appearance of other people within the image (such as staff working in the premises), and so forth. Further, such systems generally fail to recognize objects that are obstructed from field of view of a camera capturing the image (for instance, by walls), and objects that are positioned at an angle and/or distance such that identification of such objects is unfeasible. Moreover, the conventional image-based indoor navigation systems fail to accurately account for location and viewing angle of the camera while capturing the image, often leading to errors in localization of the user.

Therefore, in light of the foregoing discussion, there exists a need to overcome the aforementioned drawbacks of conventional image-based indoor navigation systems.

### SUMMARY

The present disclosure seeks to provide a method of providing information pertaining to an object within a premises. The present disclosure also seeks to provide a system for providing information pertaining to an object within a premises. The present disclosure seeks to provide a solution to the existing problem of conventional image-based navigation within indoor premises. An aim of the present disclosure is to provide a solution that overcomes at least partially the problems encountered in prior art, and provides an accurate, fast, and easy to implement method and system that accurately analyses images of the indoor premises to identify three-dimensional locations of users and objects therein.

In one aspect, an embodiment of the present disclosure provides a method of providing information pertaining to an object within a premises, the method comprising:

(i) obtaining a set of images of the premises;

(ii) creating a three-dimensional point cloud of the premises;

(iii) processing the set of images to identify at least one object and its corresponding location within the premises;

(iv) storing information pertaining to the identified at least one object, the information pertaining to the identified at least one object including location information of the identified at least one object;

(v) receiving a given image captured within the premises;

(vi) identifying a location and a viewing direction from which the given image was captured; and

(vii) locating at least one object in the given image, based upon the location and the viewing direction from (vi) and the location information from (iv).

In another aspect, an embodiment of the present disclosure provides a system for providing information pertaining to an object within a premises, the system comprising a server arrangement and a database arrangement coupled in communication with the server arrangement, wherein the server arrangement is configured to:

(1) obtain a set of images of the premises;

(2) create a three-dimensional point cloud of the premises;

(3) process the set of images to identify at least one object and its corresponding location within the premises;

(4) store information pertaining to the identified at least one object at the database arrangement, the information pertaining to the identified at least one object including location information of the identified at least one object;

(5) receive a given image captured within the premises;

(6) identify a location and a viewing direction from which the given image was captured; and

(7) locate at least one object in the given image, based upon the location and the viewing direction from (6) and the location information from (4).

Embodiments of the present disclosure substantially eliminate or at least partially address the aforementioned problems in the prior art, and provides a fast, accurate and reliable indoor navigation system.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an exemplary system for providing information pertaining to an object within a premises, in accordance with an embodiment of the present disclosure;

FIG. 2 is a top view of an exemplary premises, in accordance with an embodiment of the present disclosure;

FIGS. 3-4 are schematic illustrations of two given images captured within the exemplary premises, in accordance with different embodiments of the present disclosure;

FIGS. 5-6 are schematic illustrations of user interfaces for indicating, to users, at least one object located in views of the two given images, in accordance with different embodiments of the present disclosure; and

FIG. 7 illustrates steps of a method of providing information pertaining to an object within a premises, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method of providing information pertaining to an object within a premises, the method comprising:

(i) obtaining a set of images of the premises;

(ii) creating a three-dimensional point cloud of the premises;

(iii) processing the set of images to identify at least one object and its corresponding location within the premises;

(iv) storing information pertaining to the identified at least one object, the information pertaining to the identified at least one object including location information of the identified at least one object;

(v) receiving a given image captured within the premises;

(vi) identifying a location and a viewing direction from which the given image was captured; and

(vii) locating at least one object in the given image, based upon the location and the viewing direction from (vi) and the location information from (iv).

In another aspect, an embodiment of the present disclosure provides a system for providing information pertaining to an object within a premises, the system comprising a server arrangement and a database arrangement coupled in communication with the server arrangement, wherein the server arrangement is configured to:

(1) obtain a set of images of the premises;

(2) create a three-dimensional point cloud of the premises;

(3) process the set of images to identify at least one object and its corresponding location within the premises;

(4) store information pertaining to the identified at least one object at the database arrangement, the information pertaining to the identified at least one object including location information of the identified at least one object;

(5) receive a given image captured within the premises;

(6) identify a location and a viewing direction from which the given image was captured; and

(7) locate at least one object in the given image, based upon the location and the viewing direction from (6) and the location information from (4).

The present disclosure provides a system and method of providing information pertaining to an object within a premises. The method includes creating and updating a three-dimensional point cloud of the premises from a set of images of the premises, thereby overcoming the challenges such as requirement of detailed and update-to-date information of the premises, and/or comprehensive site survey for generation/updating of radio maps, or need for radio beacons, that are encountered in conventional indoor navigation systems. Moreover, the method and system described herein locate at least one object in a given image without implementing real time object recognition. Consequently, the method is faster to implement than conventional methods and requires less computing power on a user device. Further, the described method accurately accounts for location and viewing angle of the camera used for capturing the given image. Additionally, the methods can be adapted to support automatic model updating to reflect the changes in indoor environments, such as shifting of objects within the premises, removal of objects, and insertion of new objects within the premises. Also, the method enables identification of an object that is invisible in the captured image. Therefore, the method overcomes the drawback encountered in conventional navigation systems associated with failing to provide information related to objects that are obstructed from field of view of camera capturing the image.

The system for providing information pertaining to an object within a premises comprises a server arrangement and a database arrangement coupled in communication with the server arrangement. In an embodiment, the term ‘premises’ used herein relates to indoor environments (or indoor spaces) including at least one object therein. Examples of the premises include, but are not limited to, airports, museums, shopping malls, offices, schools, and hospitals. In another embodiment, the premises may also relate to outdoor environments such as parks or gardens, archeological sites, outdoor tourist attractions, open-air marketplaces, and so forth.

According to an embodiment, the object within the premises may comprise at least one of trademarks, logos, advertisements, texts, signs, labels, items. Specifically, the object may be a two-dimensional object or a three-dimensional object. In an example, at least one object within an art gallery premises may include paintings, sculptures and a gift shop sign. In another example, at least one object within a supermarket premises may include advertisements, a helpdesk sign, a checkout desk, and grocery, clothing and household supplies items. In yet another example, at least one object within a museum premises may include interactive models, museum exhibits, and information panels.

In an embodiment, the server arrangement may be hardware, software, firmware, or combination of these suitable for providing information pertaining to the object within the premises. Similarly, the database arrangement may be hardware, software, firmware, or combination of these suitable for storing the information pertaining to the object within the premises. Further, the database arrangement may be coupled to the server arrangement directly, or via at least one intermediary media, devices, and networks. As another example, the database arrangement and the server arrangement may be coupled in such a way that information can be passed therebetween, while not sharing any physical connection with one another. Based upon the present disclosure provided herein, one of ordinary skill in the art will appreciate a variety of ways in which such coupling may exist in accordance with the aforementioned definition.

The method of providing information pertaining to the object within the premises comprises obtaining a set of images of the premises. Specifically, the set of images may include at least one two-dimensional image of the premises. Further, the set of images may be either ordered or unordered. For example, the set of images may include 100 images, 500 images, 1000 images, 4000 images, 20000 images, and so forth.

In an embodiment, the server arrangement may obtain the set of images via crowdsourcing. In such embodiment, the set of images may include images captured by visitors of the premises. Specifically, the visitors may move within the premises to capture images thereof. Further, the images constituting the set of images may be shared by the visitors of the premises via Internet photo-sharing websites, a website of the premises, travel blogs, and so forth, wherefrom, the server arrangement may obtain the set of images. In an embodiment, the obtained set of images of the premises may be stored by the server arrangement at the database arrangement.

According to an embodiment, the set of images may be captured by the visitors using devices associated therewith. Specifically, the visitors of the premises may capture images of locations and/or objects of interest within the premises using such devices. Examples of such devices include, but are not limited to, smartphone cameras, digital cameras, laser rangefinders, Light Detection and Ranging (LiDAR) cameras, and Sound Navigation and Ranging (SONAR) cameras.

In another embodiment, the server arrangement may obtain the set of images via on-site surveying. Specifically, at least one surveyor may be engaged by a system administrator associated with the system to obtain the set of images. The at least one surveyor may move within the premises to capture images thereof. Further, in such embodiment, the set of images may be captured using surveying devices associated with the at least one surveyor. Examples of such surveying devices include, but are not limited to, smartphone cameras, digital cameras, laser rangefinders, Light Detection and Ranging (LiDAR) cameras, and Sound Navigation and Ranging (SONAR) cameras.

Further, the method comprises processing the set of images to identify at least one object and its corresponding location within the premises. The corresponding location can be two-dimensional or three-dimensional. Specifically, processing the set of images may be a multi-step process for the identification of the at least one object and the corresponding location thereof. According to an embodiment, processing the set of images may comprise employing a structure from motion algorithm. Specifically, the structure from motion algorithm may utilize correspondence (or similarity) between the images constituting the obtained set of images, for approximating the premises in three-dimensions. More specifically, the structure from motion algorithm also takes into account movement of the visitors and/or the surveyors within the premises.

In an embodiment, processing the set of images may comprise employing a pattern recognition algorithm. Specifically, employment of the pattern recognition algorithm may constitute a feature extraction step of the aforementioned structure from motion algorithm. More specifically, the pattern recognition algorithm may be implemented for each image of the set of images to allow identification of the at least one object (within the images) by recognizing features thereof. In an example, the pattern recognition algorithm may identify the at least one object by recognizing shape of the at least one object. In another example, the pattern recognition algorithm may identify the at least one object by recognizing a motif (or design) associated with the at least one object. In one embodiment, Scale-Invariant Feature Transform (SIFT) may be used to extract distinctive and invariant features from the set of images, thereby, facilitating identification of the at least one object and its corresponding location within the premises.

In another embodiment, processing the set of images may further comprise detecting pixel coordinates of the identified at least one object. Specifically, the pixel coordinates of the identified at least one object relate to (or are indicative of) location of the identified at least one object within the premises. According to embodiments of the present disclosure, the term ‘pixel coordinates’ used herein relates to two-dimensional coordinates of the identified at least one object within the image(s) including the identified at least one object. Specifically, the identified at least one object within an image may extend over multiple pixels in an image. Therefore, the pixel coordinates of the identified at least one object may be central pixel coordinates of such multiple pixels. For example, a pixel coordinate of an identified object ‘A’ within an image may be (270,120). Optionally, the pixel coordinates of the identified at least one object may be stored at the database arrangement.

According to an embodiment, processing the set of images may further comprise comparing at least one image of the set of images, with each of the remaining images of the set of images. Specifically, comparing the at least one image with each of the remaining images of the set of images may constitute a feature matching step of the aforementioned structure from motion algorithm. More specifically, such comparison may be made in order to identify common features (or patterns) between the images of the set of images. A higher number of common features may be indicative of similarity between the identified at least one object within the set of images. For example, a set of 500 images may be processed by employment of the pattern recognition algorithm thereon. Therefore, the pattern recognition algorithm may be employed to extract features from each of the 500 images. Further, each image of the set of 500 images may be compared with the remaining 499 images to identify common features therebetween.

Optionally, processing the set of images may further comprise discarding images with none or a low number of common features with the remaining images of the set of images. Specifically, such images may relate to outliers within the set of images and/or images that include few features (such as images of textureless walls). More specifically, a threshold value indicative of a minimum number of common features may be predetermined, for example, by the system administrator, or may be dynamically calculated using a mathematical function, keeping into consideration the number of features extracted in each image of the set of images. Further, in such instance, processing the set of images may further comprise updating the set of images. Specifically, the updated set of images may comprise only images with a higher number of common features therebetween, as compared to the aforementioned threshold value. Referring to the aforementioned example, 16 images with less than or equal to 2 common features (specifically, 0, 1 or 2 common features) with each of the 484 remaining images of the set of 500 images may be discarded. As can be understood from the example, a threshold value of the minimum number of common features is predetermined, and is equal to 2. Further, in such example, the set of images may be updated to include only the 484 images with significant number of common features therebetween.

It is to be understood that in an instance where no images are discarded, the updated set of images is same as the obtained set of images.

According to an embodiment, processing the set of images may further comprise implementing bundle adjustment. Specifically, implementing the bundle adjustment may constitute a feature location mapping step of the aforementioned structure from motion algorithm. More specifically, the bundle adjustment may be implemented on the updated set of images to estimate the corresponding location of the identified at least one object within the premises and camera poses of the devices (associated with the visitors) and/or the surveying devices (associated with the at least one surveyor). Further, the camera poses relate to position and orientation of cameras of the devices and/or the surveying devices. In an embodiment, the camera poses may be described using three-dimensional coordinates of position of the cameras of the devices and/or the surveying devices, focal length of the cameras, and rotation of the cameras. For example, the camera poses may be estimated using techniques such as triangulation, WiFi Fingerprinting, and so forth. In another example, Exchangeable Image File Format (EXIF) data of the images in the updated set of images may be utilized to estimate the camera poses. Further, the corresponding location of the identified at least one object may be identified based on at least one of the estimated camera poses and the detected pixel coordinates of the identified at least one object. In one embodiment, mathematical functions may be used for transforming the detected pixel coordinates of the identified at least one object into three-dimensional location coordinates indicative of true (or correct) location of the identified at least one object within the premises.

The method of providing information pertaining to the object within the premises further comprises creating a three-dimensional point cloud of the premises, the identified at least one object being represented by at least one point in the three-dimensional point cloud. Specifically, the three-dimensional point cloud may be created using output (specifically, three-dimensional coordinates of the identified at least one object) of the aforementioned processing. In an embodiment, the at least one point in the three-dimensional point cloud may correspond to the three-dimensional location coordinates of the identified at least one object identified by processing the set of images. Specifically, the three-dimensional point cloud may be a representation of the premises and the identified at least one object therein, via a three-dimensional coordinate system. More specifically, the three-dimensional coordinate system may be arbitrary and may be scaled and/or rotated to correspond to the three-dimensional coordinate systems such as World Geodetic System 84 (or WGS 84) coordinate system, coordinate system of the premises, and so forth. In addition/alternatively to three-dimensional coordinate system the coordinate system might be two-dimensional depending on target application to be used for presenting objects.

In an embodiment, the at least one point in the three-dimensional point cloud may be represented as a tuple (or any other suitable data structure). For example, the tuple may comprise at least one of the three-dimensional location coordinates of the identified at least one object, RGB (red green blue) colour of the at least one point, a list of images (of the set of images) used for reconstructing the at least one point, and features extracted in the list of images used for reconstructing the at least one point.

Further, size of the created three-dimensional point cloud of the premises may increase with the number of images constituting the obtained (and/or the updated) set of images. For example, size of a three-dimensional point cloud of a hospital premises created upon processing a set of 600 images is smaller than size of a three-dimensional point cloud of the hospital premises created upon processing a set of 3270 images. Therefore, a large-sized three-dimensional point cloud may occupy more storage space within the database arrangement and may require more time to be processed. According to an embodiment, the method may further comprise partitioning the created three-dimensional point cloud into at least two sub-clouds. Specifically, the at least two sub-clouds may occupy less storage space within the database arrangement as compared to the created three-dimensional point cloud. Further, the at least two sub-clouds may be processed in parallel. It is to be understood that sizes of the at least two sub-clouds may/may not be equal.

In an embodiment, the method may further comprise storing the created three-dimensional point cloud at the database arrangement, wherefrom the system administrator may access the created three-dimensional point cloud. Specifically, the system administrator may access and analyze the created three-dimensional point cloud for further improvisation thereof. As described previously, the three-dimensional point cloud is created on the basis of the obtained set of images of the premises and the processing thereof. However, the obtained set of images may not completely represent the entire premises as the visitors and/or the at least one surveyor may capture nil or very few images of at least one object within the premises that may be available in common life. For example, in case of a church premises including an altar, stained glass windows, carved ceiling and benches, the visitors may capture over 400 images each of the altar, the stained glass windows, and the carved ceiling, as opposed to only 70 images of the benches. In such instance, wherein the obtained set of images may not represent the entire premises, the created three-dimensional point cloud may be incomplete and may have ‘holes’ (or gaps) therein.

Therefore, the method may further comprise offering at least one incentive scheme for optimizing (or completing) the created three-dimensional point cloud. Specifically, the system administrator may offer the at least one incentive scheme (such as monetary reward, discount vouchers, printed recognition, and so forth) to the visitors of the premises. The at least one incentive scheme may encourage the visitors to capture images of every corner and space of the premises, thereby, including the at least one object within the premises that may be available in common life. Subsequently, the obtained set of images of the premises may represent the entire premises and may complete (or ‘fill in’) the holes in the created three-dimensional point cloud.

Thereafter, the method comprises storing information pertaining to the identified at least one object, the information pertaining to the identified at least one object including location information of the identified at least one object. Specifically, the information pertaining to the identified at least one object may be stored at the database arrangement by the server arrangement. In an embodiment, the location information of the identified at least one object may comprise location coordinates of the identified at least one object, and wherein the information pertaining to the identified at least one object may further comprise at least one of: a name of the identified at least one object, a type of the identified at least one object, a time stamp associated with the identified at least one object. Specifically, the location coordinates of the identified at least one object may be the three-dimensional location coordinates indicative of the true location of the identified at least one object within the premises. Optionally, a marker tag may be associated with the identified at least one object to systematically store the information pertaining thereto. Specifically, the marker tag may be a data structure. For example, information pertaining to one object such as a dinosaur's fossil in a museum premises may include name of the one object (such as ‘Tyrannosaurus Rex’), type of the one object (such as ‘exhibit’), location coordinates of the one object (such as ‘(100, 57, 340)’) and a time stamp associated with the one object (such as ‘22.10.2014 and 10:20:45 hrs’). Therefore a marker tag associated with the dinosaur's fossil may be formed, for example, as:

tag_dinosaur fossil=[‘Tyrannosaurus Rex’, ‘exhibit’, ‘(100, 57, 340)’, ‘22.10.2014 and 10:20:45 hrs’].

Optionally, the information pertaining to the identified at least one object may further include information of the at least one point (of the three-dimensional point cloud) representing the identified at least one object. Specifically, the tuple associated with the identified at least one point may be stored.

Further, the method comprises receiving a given image captured within the premises. Specifically, the given image may be a two-dimensional image captured using a user device associated with a user. The user may move within the premises to capture the given image. Further, the server arrangement may receive the given image in real-time or near real-time. More specifically, the user device may be a portable communication device. In an embodiment, the user device may have a small display or screen, such as a touch sensitive display (or screen) to render a user interface thereon. In an embodiment, the user device may also include a camera to capture the given image of the premises. In an embodiment, the system may further comprise the user device, wherein the user device may be operable to connect to the server arrangement via a network, such as the Internet, radio network, and so forth. Examples of the user device include, but are not limited to, a smartphone, a tablet computer, a camera, and a personal digital assistant (PDA).

The method further comprises identifying a location and a viewing direction from which the given image was captured. Specifically, the location and the viewing direction may be identified to ascertain position of the user within the premises whilst capturing the given image. According to an embodiment, the identifying the location and the viewing direction may comprise matching at least one feature of the given image with the three-dimensional point cloud. Specifically, the pattern recognition algorithm may be employed for extracting at least one feature of the given image. Thereafter, the given image may be compared with the three-dimensional point cloud (and specifically, the at least one point) for feature matching therebetween. The at least one point of the three-dimensional point cloud having common features with the given image may be indicative of the location and the viewing direction. Therefore, matching the at least one feature of the given image with the three-dimensional point cloud may determine a camera pose of the user device used to capture the given image. In such embodiment, real-time identification of objects in the given image is not performed. Optionally, the camera pose of the user device may be determined using techniques such as triangulation, WiFi Fingerprinting, and so forth.

In an embodiment, the identifying the location and the viewing direction may comprise matching the at least one feature of the given image with at least one of the at least two sub-clouds of the three-dimensional point cloud. Specifically, in such embodiment, selection of the at least one of the at least two sub-clouds may be performed using Global Positioning System receiver (GPS receiver) data, WiFi Fingerprinting data, in-premises user trajectory data, EXIF data of the given image, and so forth. It is to be understood that matching the at least one feature of the given image with at least one of the at least two sub-clouds may speed up the process of determining the camera pose of the user device since only a part of the three-dimensional point cloud may be analyzed at a given time.

Optionally, the at least one feature extracted from the given image may match with associated features of at least one point in the three-dimensional point cloud. Consequently, at least one camera pose of the user device may be determined. In such instance, the method may further comprise selecting a resultant camera pose of the user device from the determined at least one camera pose of the user device. Specifically, the resultant camera pose may be a midpoint (or a central value) of the determined at least one camera pose of the user device.

The method of providing information pertaining to the object within the premises further comprises locating at least one object in the given image, based upon the location and the viewing direction and the location information. Specifically, the location of the user device may be compared to the stored location information of the identified at least one object. The at least one object is located in the given image if the aforementioned locations are close to each other (or proximal). For example, a location of the user device may be obtained as (100, 210, 54). Further, the stored information pertaining to an identified object ‘P’ includes location of the object ‘P’ as (100, 212, 57). Therefore, the object ‘P’ may be located in the given image since the stored location information of the object P and the identified location of the user device are proximal.

In an embodiment, the object may include at least one object that is invisible in the given image. Specifically, the method may locate the at least one invisible object in the given image. More specifically, the at least one object that is invisible in the given image may be located if the location coordinates of the user device while capturing the given image is proximal to the stored location information of the invisible at least one object. Further the at least one invisible object might be so faraway (but within view of the image) that it cannot be recognized since it size is so small. Such faraway “invisible” object can be located within same manner than above. Referring to the aforementioned example, an object B may be positioned directly behind the object A, and may therefore be invisible in the given image. However, the location and the viewing direction of the user device whilst capturing the given image, may be proximal to the location information of the object B (specifically, the three-dimensional coordinates of the object B). Further, the object B may be represented by at least one point behind the object A (or the at least one point representing the object A) in the three-dimensional point cloud. Therefore, the object B that is invisible, may also be located within the given image.

In an embodiment of the present disclosure, the method may further comprise indicating, to a user, the at least one object located in a view of the given image. Optionally, the method may further comprise indicating, to a user, the at least one object that is invisible in the given image. Specifically, a description of the at least one object in the given image and/or the at least one object that is invisible in the given image may be presented to the user on the user interface of the user device. More specifically, the description may include the name of the at least one object, the type of the at least one object, position of the at least one object, and so forth.

According to an embodiment, the method may further comprise updating the three-dimensional point cloud of the premises. Specifically, the at least one point representing the at least one object may be updated by at least one of change in location of the at least one point, updating the list of images used for reconstructing the at least one point, addition or deletion of the at least one point, and so forth. For example, at object X represented by at least one point in the three-dimensional point cloud of the premises may have slightly moved (for example, shifted, tilted or rotated) since the creation of the three-dimensional point cloud. Therefore, in the given image, the object X may be in the slightly moved position. In such instance, location of the at least one point representing the object X may be changed for updating the three-dimensional point cloud of the premises.

In one embodiment, the method may further comprise providing the user with the user interface for enabling the user to search an object within the premises. Specifically, the user interface may be provided on the user device. More specifically, the user may search the object within the premises using as search term a name of the object, a type of the object, a trademark associated with the object, and so forth. For example, a user within a supermarket premises may search for all products of a brand ‘XYZ’ by using the user interface. In such example, the user may enter as search term ‘XYZ’ which may be a trademark associated with the brand.

According to an embodiment, the method may further comprise providing the user with recommendations related to at least one object, via the user interface. Specifically, recommendations related to the at least one object may be provided by the server arrangement in response to search of the object by the user, using the user interface. Further, the recommendations may relate to objects associated with the searched trademark, variants of the searched object, objects similar to the searched object, advertisements of discounts associated with the objects similar to the searched object, locations of the searched object and/or the objects similar to the searched object within the premises, navigation directions to the locations of the searched object and/or the objects similar to the searched object, and so forth. Referring to the aforementioned example, upon search of products of brand ‘XYZ’ by the user, the server arrangement may provide a list of products of the brand ‘XYZ’ and available discounts associated therewith.

Optionally, the method may further comprise identifying at least one sign and/or descriptive text in the given image. Specifically, the at least one sign and/or descriptive text may be identified using techniques such as, but not limited to sign recognition, and optical character recognition. In such instance, the method may further comprise detecting features from the given image and pixel coordinates of the at least one sign and/or descriptive text in the given image. Thereafter, the method may comprise comparing pixel coordinates of the detected features and pixel coordinates of the at least one sign and/or descriptive text. Further, the method may comprise assigning as location of the at least one sign and/or descriptive text, the pixel coordinates of the detected feature that is closest to the at least one sign and/or descriptive text.

### DETAILED DESCRIPTION OF THE DRAWINGS

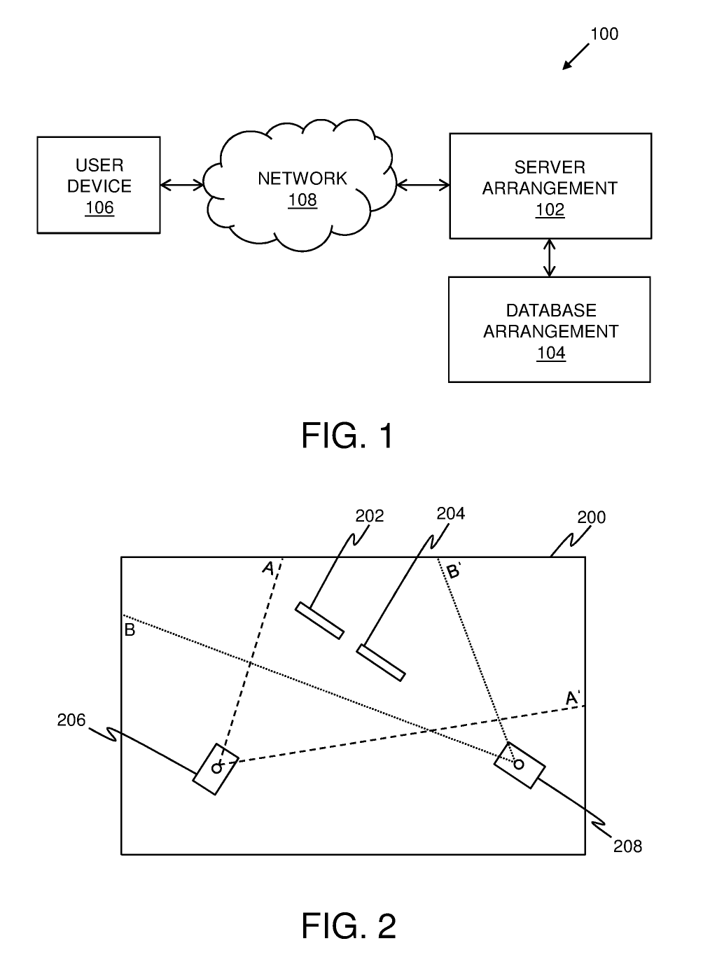

Referring to FIG. 1, illustrated is a schematic illustration of an exemplary system 100 for providing information pertaining to an object within a premises, in accordance with an embodiment of the present disclosure. As shown, the system 100 includes a server arrangement 102 and a database arrangement 104 coupled in communication with the server arrangement 102. Further, the system 100 includes a user device 106 associated with a user. The user device 106 is operable to connect to the server arrangement 102 via a network 108, such as the Internet, radio network, and so forth. Examples of the user device 106 include, but are not limited to, a smartphone, a tablet computer, a camera, and a personal digital assistant (PDA).

Referring to FIG. 2, illustrated is a top view of an exemplary premises 200, in accordance with an embodiment of the present disclosure. As shown, the premises 200 includes at least one object therein, depicted as an object 202 and an object 204. In an example, a first user (not shown) associated with a first user device 206, and a second user (not shown) associated with a second user device 208, may move within the premises 200 to capture images within the premises 200. As shown, a viewing direction of camera of the first user device 206 is represented as the region between dashed lines A and A′. Similarly, a viewing direction of camera of the second user device 208 is represented as the region between dotted lines B and B′.

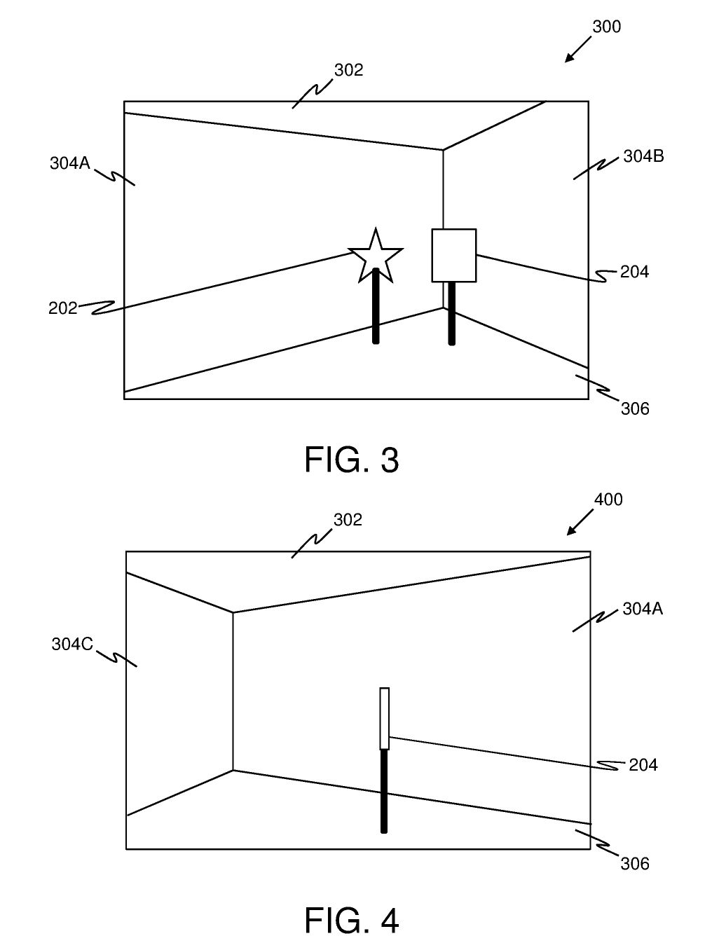

Referring to FIG. 3, illustrated is a schematic illustration of a first given image 300 captured within the exemplary premises 200 (of FIG. 2), in accordance with an embodiment of the present disclosure. The first given image 300 is captured using the first user device 206 (shown in FIG. 2) associated with the first user. As shown, the first given image 300 includes the object 202 and the object 204. Further, the first given image 300 depicts a roof 302, walls 304A and 304B, and a floor 306 of the exemplary premises 200.

Referring to FIG. 4, illustrated is a schematic illustration of a second given image 400 captured within the exemplary premises 200 (of FIG. 2), in accordance with another embodiment of the present disclosure. The second given image 400 is captured using the second user device 208 (shown in FIG. 2) associated with the second user. As shown, the second given image 400 includes the object 204. Further the object 202 is invisible in the second given image 400 as the object 202 is positioned directly behind the object 204, according to the viewing direction of camera of the second user device 208. Further, the second given image 400 depicts the roof 302, walls 304A and 304 C, and floor 306 of the exemplary premises 200.

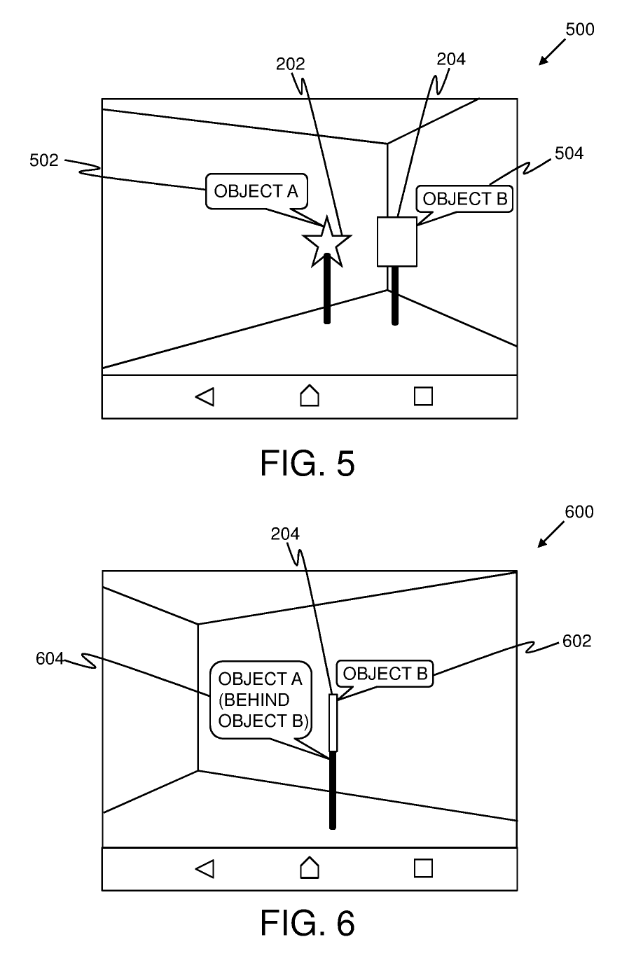

Referring to FIG. 5, illustrated is a schematic illustration of a user interface 500 for indicating, to the first user, at least one object (such as the object 202 and the object 204 of FIG. 3) located in view of the first given image 300, in accordance with an embodiment of the present disclosure. The user interface is rendered on the first user device 206 (shown in FIG. 2) associated with the first user. As shown, a description 502 of the object 202, and a description 504 of the object 504 are presented to the user on the user interface 500. The description 502 includes name of the object 202 as ‘OBJECT A’. The description 504 includes name of the object 204 as ‘OBJECT B’.

Referring to FIG. 6, illustrated is a schematic illustration of a user interface 600 for indicating, to the second user, at least one object (such as the object 202 and the object 204 of FIG. 3) located in view of the second given image 400, in accordance with an embodiment of the present disclosure. The user interface is rendered on the second user device 208 (shown in FIG. 2) associated with the second user. As shown, a description 602 of the object 204 is presented to the user on the user interface 600. The description 602 includes name of the object 204 as ‘OBJECT B’. Further, a description 604 of the object 202 that is invisible in the second given image 400 is also presented on the user interface 600. The description 604 includes name and position of the object 202 as ‘OBJECT A (BEHIND OBJECT B)’.

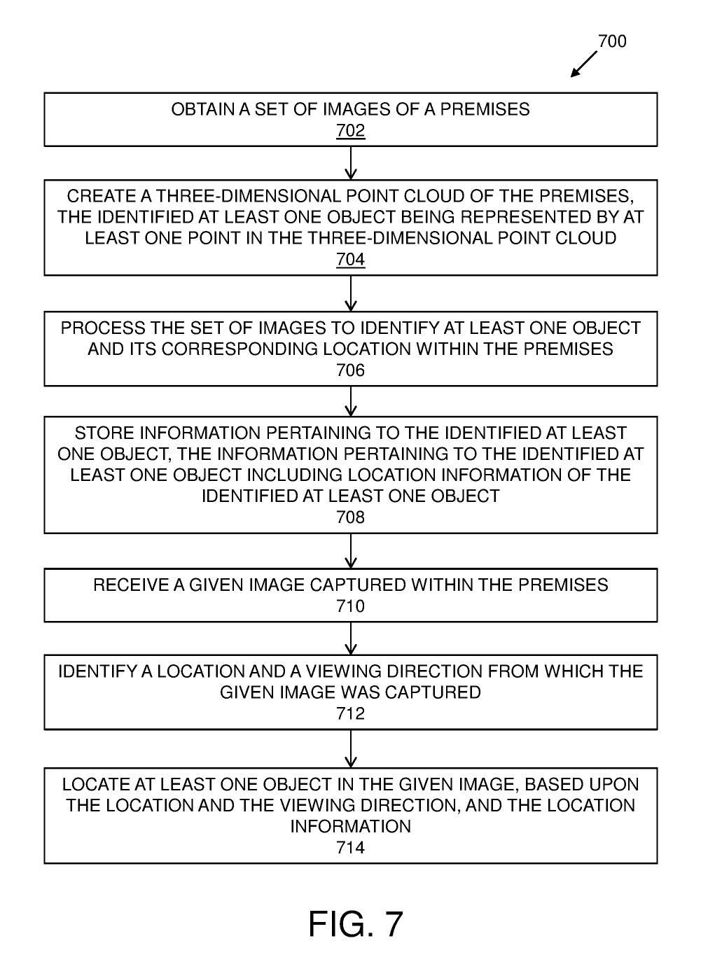

Referring to FIG. 7 illustrated are steps of a method 700 of providing information pertaining to an object within a premises, in accordance with an embodiment of the present disclosure. At step 702, a set of images of a premises is obtained. At step 704, a three-dimensional point cloud of the premises is created, the identified at least one object being represented by at least one point in the three-dimensional point cloud. At step 706, the set of images is processed to identify at least one object and its corresponding location within the premises. At step 708, information pertaining to the identified at least one object is stored, the information pertaining to the identified at least one object including location information of the identified at least one object. At step 710, a given image captured within the premises is received. At step 712, a location and a viewing direction from which the given image was captured is identified. At step 714, at least one object is located in the given image, based upon the location and the viewing direction, and the location information.

The steps 702 to 714 are only illustrative and other alternatives can also be provided where one or more steps are added, one or more steps are removed, or one or more steps are provided in a different sequence without departing from the scope of the claims herein. For example, the method 700 may further comprise indicating, to a user, the at least one object located in a view of the given image. Optionally, in the method 700, the object may include at least one object that is invisible in the given image. In another example, the method 700 may further comprise updating the three-dimensional point cloud of the premises, based upon the at least one object located in the given image. Optionally, in the method 700, the processing the set of images may comprise employing a pattern recognition algorithm. More optionally, in the method 700, the processing the set of images may comprise employing a structure from motion algorithm. In an example, in the method 700, the location information of the identified at least one object may comprise location coordinates of the identified at least one object, and wherein the information pertaining to the identified at least one object may further comprise at least one of: a name of the identified at least one object, a type of the identified at least one object, a time stamp associated with the identified at least one object. In another example, in the method 700, the identifying the location and the viewing direction may comprise matching at least one feature of the given image with the three-dimensional point cloud. Optionally, the method 700 may further comprise providing a user with a user interface for enabling the user to search an object within the premises. For example, the method 700 may further comprise providing the user with recommendations related to at least one object, via the user interface.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of providing information pertaining to an object within a premises, the method comprising:
(i) obtaining a set of images of the premises;
(ii) creating a three-dimensional point cloud of the premises;
(iii) processing the set of images to identify at least one object and its corresponding location within the premises;
(iv) storing information pertaining to the identified at least one object, the information pertaining to the identified at least one object including location information of the identified at least one object;
(v) receiving a given image captured within the premises;
(vi) identifying a location and a viewing direction from which the given image was captured; and
(vii) locating at least one object in the given image, based upon the location and the viewing direction from (vi) and the location information from (iv).

2. A method of claim 1, further comprising indicating, to a user, the at least one object located in a view of the given image.

3. A method of claim 1, wherein the object from (vii) includes at least one object that is invisible in the given image.

4. A method of claim 1, further comprising updating the three-dimensional point cloud of the premises.

5. A method of claim 1, wherein the processing the set of images at (iii) comprises employing a pattern recognition algorithm.

6. A method of claim 1, wherein the processing the set of images at (iii) comprises employing a structure from motion algorithm.

7. A method of claim 1, wherein the identifying the location and the viewing direction at (vi) comprises matching at least one feature of the given image with the three-dimensional point cloud.

8. A method of claim 1, wherein the location information of the identified at least one object from (iv) comprises location coordinates of the identified at least one object, and wherein the information pertaining to the identified at least one object from (iv) further comprises at least one of: a name of the identified at least one object, a type of the identified at least one object, a time stamp associated with the identified at least one object.

9. A method of claim 1, further comprising providing a user with a user interface for enabling the user to search an object within the premises.

10. A method of claim 9, further comprising providing the user with recommendations related to at least one object, via the user interface.

11. A system for providing information pertaining to an object within a premises, the system comprising a server arrangement and a database arrangement coupled in communication with the server arrangement, wherein the server arrangement is configured to:
(1) obtain a set of images of the premises;
(2) create a three-dimensional point cloud of the premises;
(3) process the set of images to identify at least one object and its corresponding location within the premises;
(4) store information pertaining to the identified at least one object at the database arrangement, the information pertaining to the identified at least one object including location information of the identified at least one object;
(5) receive a given image captured within the premises;
(6) identify a location and a viewing direction from which the given image was captured; and
(7) locate at least one object in the given image, based upon the location and the viewing direction from (6) and the location information from (4).

12. A system of claim 11, wherein the server arrangement is configured to indicate, to a user, the object located in a view of the given image.

13. A system of claim 11, wherein the object from (7) includes at least one object that is invisible in the given image.

14. A system of claim 11, wherein the server arrangement is configured to update the three-dimensional point cloud of the premises, based upon the at least one object located in the given image.

15. A system of claim 11, wherein when processing the set of images at (3), the server arrangement is configured to employ a pattern recognition algorithm.

16. A system of claim 11, wherein when processing the set of images at (3), the server arrangement is configured to employ a structure from motion algorithm.

17. A system of claim 11, wherein when identifying the location and the viewing direction at (6), the server arrangement is configured to match at least one feature of the given image with the three-dimensional point cloud.

18. A system of claim 11, wherein the location information of the identified at least one object from (4) comprises location coordinates of the identified at least one object, and wherein the information pertaining to the identified at least one object from (4) further comprises at least one of: a name of the identified at least one object, a type of the identified at least one object, a time stamp associated with the identified at least one object.

19. A system of claim 11, wherein the server arrangement is configured to provide a user with a user interface for enabling the user to search an object within the premises.

20. A system of claim 19, wherein the server arrangement is configured to provide the user with recommendations related to at least one object, via the user interface.
